(19) United States
(12) Patent Application Publication
(10) Pub. No.: US 2013/0124298 A1
(43) Pub. Date: May 16, 2013

(54) GENERATING CLUSTERS OF SIMILAR USERS FOR ADVERTISEMENT TARGETING

(71) Applicants: Huajing Li, Sunnyvale, CA (US); Yanxin Shi, Palo Alto, CA (US); Rohit Dhawan, San Francisco, CA (US); Richard Bill Sim, Foster City, CA (US); Rong Yan, Mountain View, CA (US); David Dawei Ye, Palo Alto, CA (US)

(72) Inventors: Huajing Li, Sunnyvale, CA (US); Yanxin Shi, Palo Alto, CA (US); Rohit Dhawan, San Francisco, CA (US); Richard Bill Sim, Foster City, CA (US); Rong Yan, Mountain View, CA (US); David Dawei Ye, Palo Alto, CA (US)

(21) Appl. No.: 13/297,117

(22) Filed: Nov. 15, 2011

(51) Int. Cl. G06Q 30/02

(52) U.S. Cl. 705/14.42; 705/14.66; 705/14.53; 705/14.58

(57) ABSTRACT

A social networking system may identify a first set of users as part of a training cluster and identify a second set of users that is similar to the first set of users for purposes of targeting advertisements related to the advertiser. Using past engagement history (e.g., click-through rates), demographic information, and keywords associated with the training cluster of users, a social networking system may generate a training model specific to the training cluster. Confidence scores may be used to identify similar users across the total population of users of the social networking system for creating a targeting cluster of users for the advertisement. A revenue sharing scheme may be used induce page administrators to increase their fan base by enabling advertisers to target advertisements to users that have expressed interest in pages associated with the page administrators.

### BACKGROUND

This invention relates generally to social networking, and in particular to targeting users of a social networking system that are similar to a training cluster of users.

Traditional advertisers used focus groups and demographic data to gain an understanding of how to design and implement effective ad campaigns. For example, a sports drink advertiser may use a random sampling of a target population, such as 18-35 year-old men, to determine whether an ad would be effective. However, this approach to advertising targeting may lead to inefficient ad spending because advertisements may be presented to viewers that are not interested in sports or exercise, for example.

In recent years, social networking systems have made it easier for users to share their interests and preferences in real-world concepts, such as their favorite movies, musicians, celebrities, brands, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Although advertisers may have some success in targeting users based on interests and demographics, tools have not been developed to target similar users.

Specifically, users that have similar characteristics to a set of users that have previously engaged with a brand have not been identified on a social networking system for ad targeting. A social networking system may have millions of users that have expressed interests and previously engaged with advertisements. However, existing systems have not provided efficient mechanisms of identifying similar users that have previously engaged with a particular brand for targeting advertisements.

### SUMMARY

A social networking system may identify a first set of users as part of a training cluster and identify a second set of users that is similar to the first set of users for purposes of targeting advertisements related to the advertiser. In one embodiment, the training cluster of users may be defined by targeting criteria of an advertisement as users that have previously engaged with the advertisement. In another embodiment, the training cluster of users may be defined by targeting criteria of an advertisement as users that have interacted with the social networking system in a certain way, such as expressing interest in a page, commenting within a page, installing an application, and engaging with the application. Embodiments of the invention generate training models based on the training clusters of users. Using past engagement history (e.g., click-through rates), demographic information, and keywords associated with the training clusters of users, a social networking system may generate a training model specific to a training cluster of users. Confidence scores may be used to identify similar users across populations of users of the social networking system. In one embodiment, a revenue sharing scheme may be used to induce page owners to increase their fan base to enable advertisers to target advertisements to users who have expressed interest in other pages.

### BRIEF DESCRIPTION OF THE DRAWINGS

FIG. 1 is high level block diagram illustrating a process for generating user models to target similar users of a social networking system, in accordance with an embodiment of the invention.

FIG. 2 is a network diagram of a system for generating user models to target similar users of a social networking system, showing a block diagram of the social networking system, in accordance with an embodiment of the invention.

FIG. 3 is high level block diagram illustrating a user model generating module that includes various modules for generating user models for targeting similar users of a social networking system, in accordance with an embodiment of the invention.

FIG. 4 is a flowchart of a process for generating user models to target similar users of a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. Each of the interactions with an object may be recorded by the social networking system as an edge. Enabling third-party developers to define custom object types and custom action types is described further in “Structured Objects and Actions on a Social Networking System,” U.S. application Ser. No. 13/239,340 filed on Sep. 21, 2011, which is hereby incorporated by reference.

Advertisers may engage with users of a social networking system through different communication channels, including direct advertisements, such as banner ads, indirect advertisements, such as sponsored stories, generating a fan base for a page on the social networking system, and developing applications that users may install on the social networking system. An advertiser would benefit from identifying other users that are similar to users that have already engaged with an advertiser's product, brand, application, and the like. In turn, a social networking system would benefit from increased advertising revenue by enabling advertisers to target these other users that exhibit similar characteristics to the users that have already engaged with the advertiser, either through clicking on an advertisement, expressing an interest in a page owned by the advertiser, or installing an application associated with the advertiser.

A social networking system may select a training cluster of users that may be associated with an advertiser through one of these communication channels. In one embodiment, a group of users may be labeled by advertisers for inclusion in a training cluster of users. In one embodiment, a group of users may be labeled by advertisers according to a rule created by advertisers, such as users that have previously clicked on an advertisement. In another embodiment, advertisers may label a group of users through an application programming interface or a user interface. A classifier algorithm may be used to analyze characteristics, or features, about the training cluster of users to generate a user model that may be used to identify other users of the social networking system that are similar to the training cluster of users. Such features may include keywords associated with the users' profiles, demographics of the users, and the users' history of interactions with other advertisers. Machine learning may be used in determining the features that are selected to generate the user model. In one embodiment, social graph information may be used to filter the similar users, such as including only users that are directly or indirectly connected to the users in the training cluster. In another embodiment, separate targeting criteria, such as location and demographics criteria, may be used to filter the similar users. Demographics includes age, gender, and other standard targeting dimensions of information about users of the social networking system. The use of filters on a targeting cluster of similar users limits the size of the targeting cluster. Once the user model has been generated, the advertiser may target advertisements to the generated cluster of similar users.

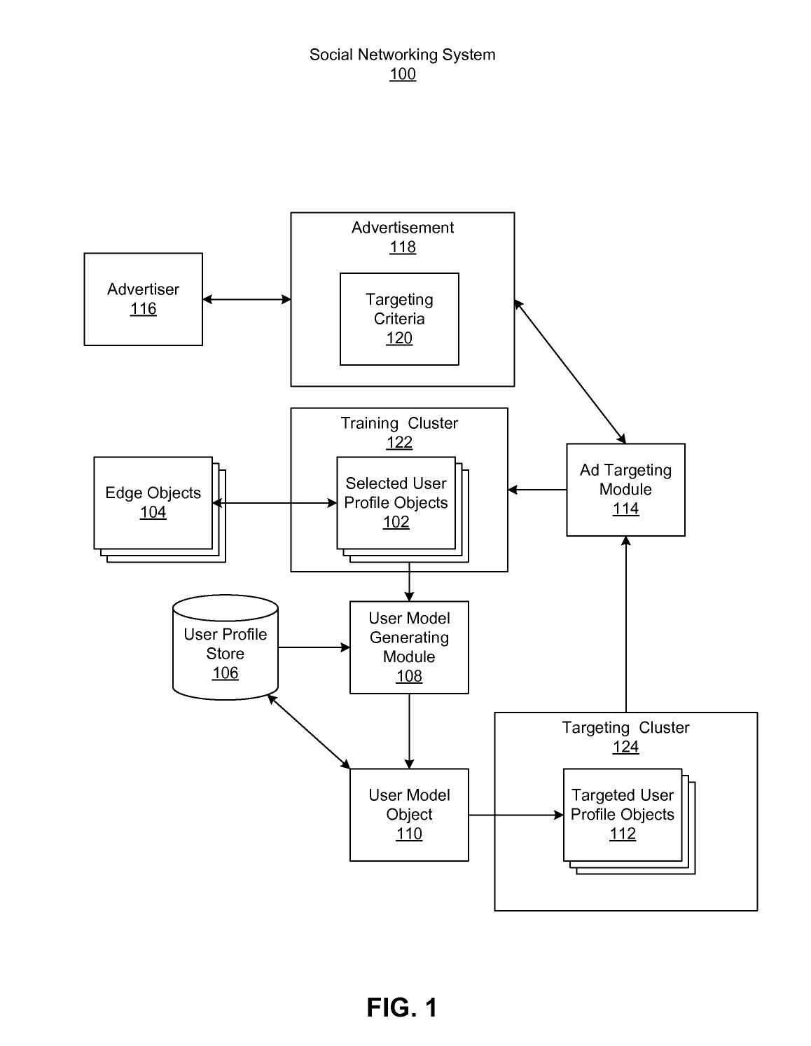

FIG. 1 illustrates a high level block diagram of a process of generating user models to target similar users of a social networking system, in one embodiment. An advertisement 118 includes targeting criteria 120 selected by an advertiser 116 that may request a targeting cluster 124 of users that are generated from a training cluster 122 of users defined by the targeting criteria 120. An ad targeting module 114 may receive the targeting criteria 120 included in the advertisement 118 and define the training cluster 122 accordingly. The social networking system 100 includes selected user profile objects 102 that are associated with edge objects 104. The selected user profile objects 102 are stored in a user profile store 106 in the social networking system 100. As users engage with advertisers on a social networking system 100, edge objects 104 are generated that are associated with the users' user profile objects. Upon the request for a targeting cluster 124 of users that are similar to a training cluster 122 of users defined by targeting criteria selected by an advertiser 116, a social networking system 100 may determine edge objects 104 that are associated with the advertiser 116 and the selected user profile objects 102 of the users that previously engaged with the advertiser 116, in one embodiment. In another embodiment, selected user profile objects 102 may be determined by the social networking system 100 based on characteristics of the selected user profile objects 102, using keywords, demographics, and advertiser engagement history of the users associated with the selected user profile objects 102.

In a further embodiment, the selected user profile objects 102 are identified by interactions with systems internal and external to the social networking system 100, such as a list of user identifiers that interacted with a particular object on the social networking system 100, such as a page, an application, or other object on the social networking system 100, as well as a list of user identifiers that interacted with a website external to the social networking system 100. The social networking system 100 may identify users that have installed a specific application, such as a social gaming application, to identify the selected user profile objects 102, in one embodiment. In another embodiment, a social networking system 100 may receive information about users watching movies on a video streaming service, such as Netflix and Hulu, and identify their associated user profile objects 102. As another example, a social networking system 100 may receive identifying information about users playing games on a third-party website. Advertisers for the video streaming service and the gaming application may desire to target advertisements to other users of the social networking system 100 that are similar to user that have performed these actions on external systems. In this way, advertisers may identify a group of labeled users that are to be included in the training cluster using a list of user identifiers for users of the social networking system 100. In yet another embodiment, a training cluster of users may include users that are relevant to an advertisement campaign. For example, an advertisement campaign may be selling baby food and a group of users that are new parents may be included in a training cluster because new parents may be in the market to buy baby food. Separate processes in the social networking system 100 may enable advertisers to identify these relevant users. In order to identify a targeting cluster 124 of similar users to the training cluster 122 of users associated with the selected user profile objects 102, a user model is generated by the social networking system 100.

A user model generating module 108 may receive the selected user profile objects 102 in a request to generate a user model for the advertiser 116. The user model generating module 108 may generate a user model object 110 based on an analysis of the features, or characteristics, of the users associated with the selected user profile objects 102. Once a user model object 110 has been generated for the advertiser 116, targeted user profile objects 112 may be determined from all of the user profile objects stored in the user profile store 106. As a result, the user model object 110, based on the selected features of the selected user profile objects 102 by the user model generating module 108, may be applied to populations of users of the social networking system 100. Populations of users of the social networking system 100 may include all users of the social networking system 100 as well as filtered groups of users based on geographic location, demographic information, the social graph, and other filtering criteria. The targeted user profile objects 112 represent users that are similar to the users that engaged with the advertiser 116.

An ad targeting module 114 receives the targeted user profile objects 112 as a targeting cluster 124 of users that the advertisement 118 may be provided to for display. As a result, an advertiser 116 may target an advertisement 118 to a targeting cluster 124 of users of the social networking system 100 that are similar to a training cluster 122 of users as defined by targeting criteria 120 included in the advertisement 118, such as users that have engaged with similar advertisements, users that have performed an interaction with a specified object on the social networking system 100, as well as users that have performed a particular action on a system external to the social networking system 100. Further, users that have been identified by advertisers to be part of a training cluster 122 of users may also be used by the social networking system 100 to generate a targeting cluster 124 of users.

### System Architecture

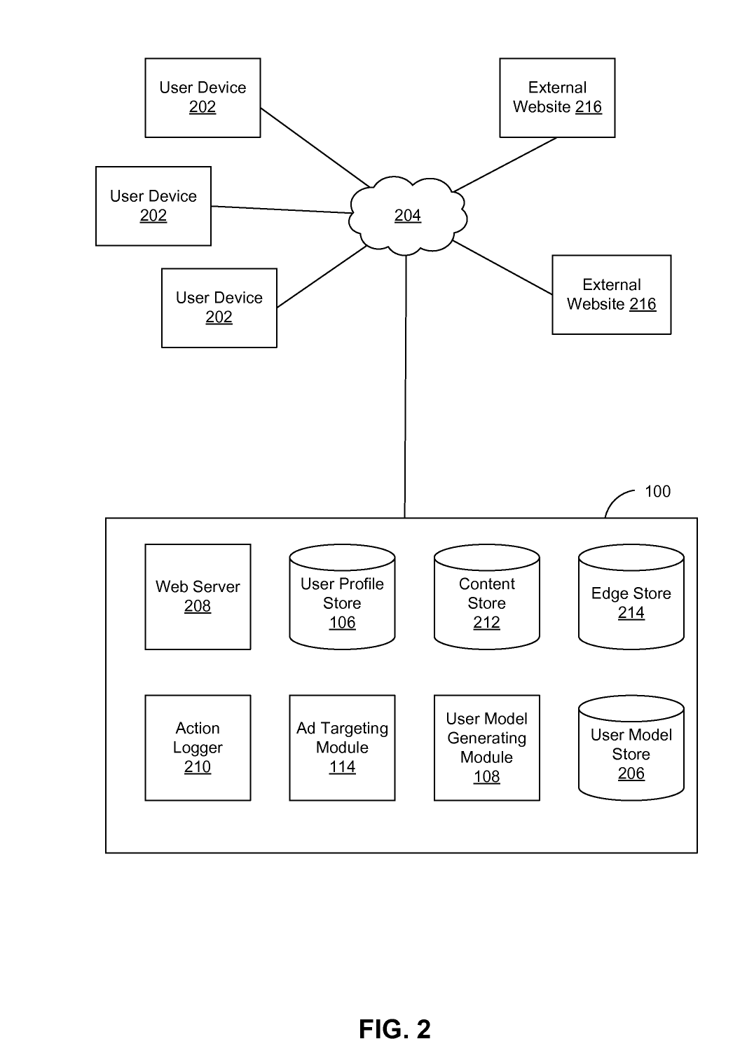

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 106, a user model generating module 108, an ad targeting module 114, a user model store 206, a web server 208, an action logger 210, a content store 212, and an edge store 214. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for a user are stored in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

An ad targeting module 114 may receive targeting criteria for advertisements for display to users of a social networking system 100. Targeting criteria may be received from advertisers to filter users by demographics, social graph information, and the like. Demographics may include information about users of the social networking system, such as age, gender, political views, education status, college year, relationship status, gender(s) interested in dating, and geographic region information. A social graph filter may filter users based on whether the users in the targeting cluster are directly or indirectly connected to users in the training cluster of users used to generate a user model for the advertiser, in one embodiment. A social graph filter may also filter users based on whether the users in the targeting cluster are directly or indirectly connected to a specified user or group of users, in another embodiment. Other filters may include filtering by interests, applications installed on the social networking system 100, groups, networks, and usage of the social networking system 100. Targeting criteria for an advertisement may also include a generated set of users that are similar to users that have previously engaged with the advertisement or the advertiser for the advertisement. A user model generated by the social networking system 100 may be used to generate the set of users that are similar to users that have previously engaged with the advertiser or advertisement.

### Generating a User Model for an Advertiser on a Social Networking System

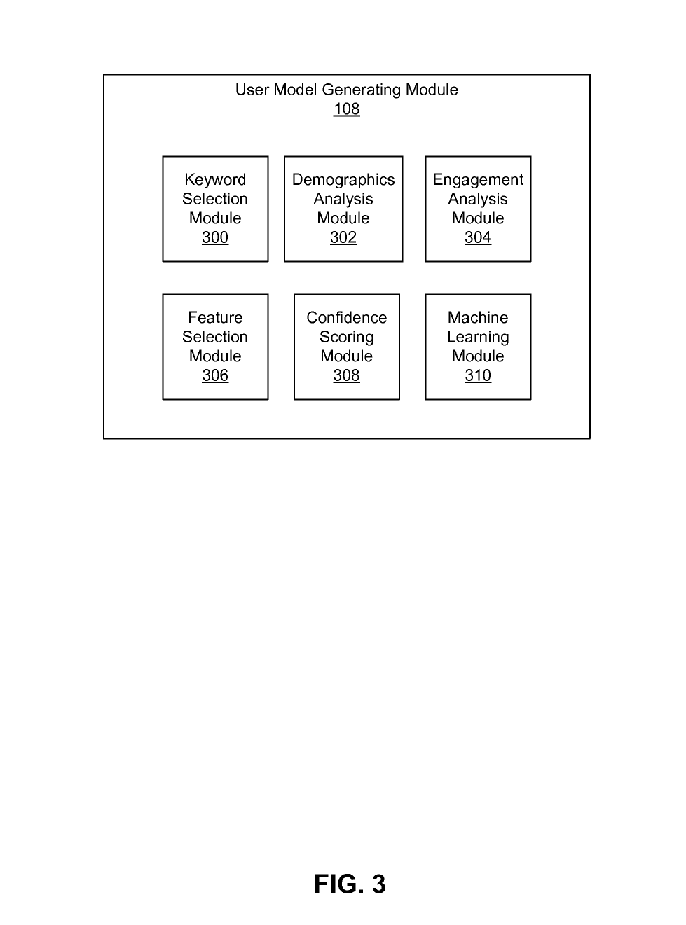

FIG. 3 illustrates a high level block diagram of the user model generating module 108 in further detail, in one embodiment. The user model generating module 108 includes a keyword selection module 300, a demographics analysis module 302, an engagement analysis module 304, a feature selection module 306, a confidence scoring module 308, and a machine learning module 310. These modules may perform in conjunction with each other or independently to develop a user model for determining a targeting cluster of users based on a training cluster of users on a social networking system 100.

A keyword selection module 300 determines keywords to be selected for a user model that describe users in a training cluster of users for a particular advertiser. A keyword profile may be maintained for each user of a social networking system that includes keywords that describe the user based on the user's profile and actions performed by the user on the social networking system. For example, a user may express interest in broad categories of interests, such as dancing, sleeping, music, and jazz. Those keywords may be added to the user's keyword profile. Additionally, the user may also perform interactions with various objects on the social networking system and outside of the social networking system that indicate an interest in those objects. For example, a user may share links about celebrity gossip, perform searches on the social networking system for brands, install gaming applications, interact with posts on pages on the social networking system, and the like. Through a user's interactions on the social networking system, as well as the user's interactions with external systems captured by the social networking system, a keyword profile for the user may be populated with thousands of keywords. The keyword selection module 300 analyzes the keyword profiles of the users in the training cluster of users that have engaged with the advertiser to determine a set of keyword features for the user model. In one embodiment, a predetermined number of keywords are reduced from each user's keyword profile (e.g., 100 keywords) to be selected for the user model.

A demographics analysis module 302 analyzes demographic information about the training cluster of users for generating a user model for an advertiser. In one embodiment, the demographics analysis module 302 analyzes various demographic information about the users in the training cluster of users for an advertiser, including age, gender, political views, education status, college year, relationship status, gender(s) interested in dating, and region FIPS information (geographic region information). In this way, the demographics analysis module 302 may select types of demographic information as features for a user model for an advertiser based on a type of demographic information being statistically relevant, in one embodiment. For example, if a training cluster of users that previously engaged with an advertiser by clicking an advertisement included, disproportionately, female users aged 18-35, the age and gender demographic types may be included as features in the user model for the advertiser. In another embodiment, the demographics analysis module 302 may include all demographic types as features in the user model for the advertiser. The demographics analysis module 302 may use the demographics information about the training cluster of users that engaged with the advertiser in the machine learning model to generate the user model for the advertiser.

An engagement analysis module 304 analysis the engagement of users of the training cluster of users that previously engaged with the advertiser. In one embodiment, past click behaviors of the training cluster of users are analyzed to determine a distribution of past click behavior by the users in the training cluster. The users in the training cluster may be mapped to bins according to the distribution of past click behavior. After the user model is created and applied to the total population of users of the social networking system, the total population of users are mapped to the same bins according to their distribution of past click behavior and the same percentage of users are selected from the bins. As a result, the click through rates of the users in the training cluster may be normalized to avoid selecting users that click on all ads.

In another embodiment, the engagement analysis module 304 analyzes other engagement information about the users in the training cluster, such as expressing interest in a page on the social networking system (becoming a “fan” of a page or “liking” a page) and installing an application on the social networking system. Users may be sorted by their distribution of engagement with advertisers on the social networking system into bins in a similar way as described above. For example, users may be segmented by the number of pages on the social networking system that the users have expressed interest in or by the number of applications the users have installed on the social networking system. Once the user model has been generated for the advertiser based on the training cluster of users and applied to the total population of users, the same percentage of users may be selected from the bins to normalize the engagement information of the users in the training cluster.

A feature selection module 306 determines features for generating the user model based on the training cluster of users that engaged with the advertiser. In one embodiment, a predetermined number of features are selected for the types of user characteristics analyzed about the training cluster, including keywords, demographics, and engagement. For example, 100 keyword features may be selected from each user's keyword profile, where the top 10,000 keywords are considered. As another example, the past 75 clicks on advertisements associated with advertisers from each user's past click behavior during a training period may be used as features, where the top 10,000 advertisers are considered. In another embodiment, the feature selection module 306 may select features for the user model based on statistically significant characteristics of the training cluster in comparison to the total population of users of the social networking system. For example, if users from urban regions that are interested in dance clubs are disproportionately engaging with an advertiser, based on the total population of users, then those features (urban regions and an interest in dance clubs) may be selected for the user model for the advertiser.

In one embodiment, the feature selection module 306 may select social graph features of users in the training cluster in generating user models for advertisers. Various types of social graph features may be used in a user model, including a user being connected to multiple users in the training cluster, a user being connected to at least one user in the training cluster, a user interacting with multiple users in the training cluster, and a user that regularly shares content with other users of the social networking system. For example, a user that is connected to a predetermined threshold number of users in the training cluster may satisfy a social graph feature for the user model that increases the confidence score for that user. Social graph features may be determined by a social networking system 100 through analyzing edge objects associated with the users of the social networking system 100.

A confidence scoring module 308 may be used to determine confidence scores for users of the social networking system based on a generated user model for an advertiser. Confidence scores may be determined based on whether users exhibit features in the user model. As a user exhibits more features in the user model for an advertiser, the confidence score for that user increases. In one embodiment, after the total population of users of a social networking system has been distributed into bins according to past engagement with advertisers, confidence scores are assigned to the total population of users for a user model. The same percentage of users is selected from each of the bins to ensure normalization of engagement behavior. The top confidence scoring users from each of the bins are selected, in one embodiment.

A machine learning module 310 is used in the user model generating module 108 to select features for user models generated for advertisers. In one embodiment, a social networking system 100 uses a machine learning algorithm to analyze user characteristics of a training cluster of users that have engaged with an advertiser by clicking on an advertisement, for example. The machine learning module 310 may select user characteristics as features for the user model for the advertiser, such as keyword features, demographic features, and advertiser click features, using at least one machine learning algorithm. In another embodiment, a machine learning algorithm may be used to optimize the selected features for a user model based on conversion rates of advertisements targeted to users identified from the user model. A selected feature in a user model may be removed based on a lack of engagement by users targeted by the advertiser based on the user model that exhibit the selected feature. For example, a selected feature for a user model may include a high affinity score for Starbucks Coffee. However, if users exhibiting a high affinity score for Starbucks Coffee do not engage with the advertisement in expected numbers, then the machine learning algorithm may deselect the feature in the user model.

Any type of user information may be used as a feature in a user model, such as user tenure on the social networking system and social graph information. User tenure may be defined as a period of time that the user has been part of the social networking system. Social graph information may include simple queries on connections of users in the training cluster as well as more complex queries about the strength and/or weakness of the connections of the users. For example, social graph information, such as whether users are close friends of the users in the training or mere acquaintances, may be used a feature in a user model.

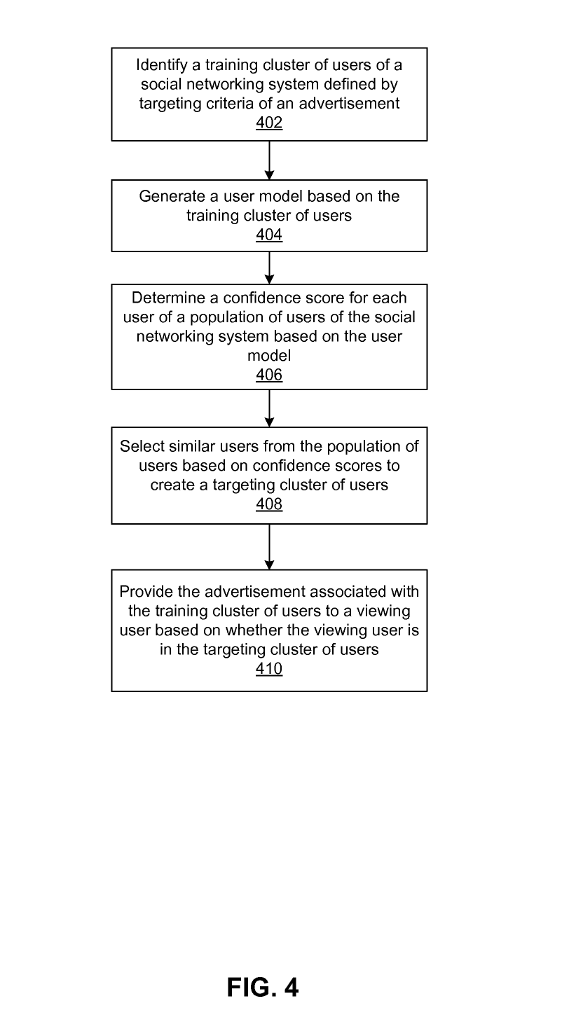

FIG. 4 illustrates a flow chart diagram depicting a process of generating user models to target similar users of a social networking system, in accordance with an embodiment of the invention. A training cluster of users of a social networking system is identified 402 as defined by targeting criteria of an advertisement. In one embodiment, the training cluster of users is identified 402 as engaging with an advertiser by installing an application on the social networking system associated with the advertiser. In another embodiment, the training cluster of users is identified 402 as users expressing interest in a page on a social networking system. In a further embodiment, the training cluster of users is identified 402 as users engaging with an advertiser by clicking on an advertisement associated with the advertiser. The training cluster of users may be identified 402 by receiving identifying information about the users in the training cluster of users, such as a list of user identifiers. In another embodiment, user identifiers of the users in the training cluster are identified 402 by the social networking system 100 as users performing an action in the social networking system 100 having a particular action type, or edge type. An advertiser may, in one embodiment, label users for the social networking system 100 to identify 402 users to be included in the training cluster of users. In one embodiment, advertisers may label users through a user interface with the social networking system 100. In another embodiment, advertisers may label users through an application programming interface (API). In a further embodiment, advertisers may define rules to automatically label users that meet certain criteria, such as previously clicking on an advertisement or expressing interest in a page on the social networking system.

After the training cluster of users is identified 402, a user model based on the training cluster of users is generated 404. Features of the training cluster of users are selected to generate 404 the user model, including keyword features, demographic features, and engagement behavior features, such as past click behavior associated with advertisers. In another embodiment, social graph features may be selected to generate 404 the user model, such as analyzing mutual connections of users in the training cluster, determining strength and/or weaknesses of user connections of users in the training cluster and a potential targeting cluster of users, and querying whether users in the potential targeting cluster are directly or indirectly connected to users in the training cluster. Machine learning algorithms may be used to select the features in the user model based on the training cluster of users. In another embodiment, any type of user information may be used as a feature in the user model, such as user tenure in the social networking system.

Once a user model based on the training cluster of users is generated 404, a confidence score for each user of a population of users of the social networking system is determined 406 based on the user model. In one embodiment, confidence scores may be determined 406 for a population of users of a particular geographic location, such as the United States. In another embodiment, confidence scores may be determined 406 for a population of users of a particular community, network, or group. In yet another embodiment, confidence scores may be determined 406 for all users of the social networking system.

Confidence scores may be determined 406 for a total population of users of the social networking system by distributing the total population of users into bins according to a distribution of engagement behavior history of the training cluster of users, in one embodiment. For example, the training cluster of users may include a spectrum of engagement behavior history, from users that click on every advertisement to users that rarely click on an advertisement. The population of users may be distributed into the bins by analyzing each user's engagement behavior history, such as clicking on advertisements. Other types of engagement behavior may include users installing an application on the social networking system associated with an advertiser and users expressing interest in a page on the social networking system associated with an advertiser.

As a result of determining 406 confidence scores based on the user model for a population of users of the social networking system, similar users may be selected 408 from the population of users based on the confidence scores. In one embodiment, a predetermined percentage of top confidence scoring users are selected 408 from the bins. In this way, prior engagement behavior has been normalized. In another embodiment, users in the population of users that meet or exceed a predetermined threshold confidence score are selected 408.

Once the similar users have been selected 408 from the population based on confidence scores, an advertisement associated with the training cluster of users is provided 410 to the selected similar users. The advertisement provided 410 to the selected similar users may be the same advertisement that the training cluster of users previously clicked on, in one embodiment. In another embodiment, the provided advertisement is associated with the advertiser associated with the users in the training cluster, such as installing an application on the social networking system associated with the advertiser and expressing interest in a page on the social networking system associated with the advertiser. The advertisement is provided 410 for display to the selected similar users.

In one embodiment, the training cluster of users is identified 402 from a received list of user identifiers as requested by targeting criteria included in an advertisement. A user model may be generated 404 based on the training cluster of users and a confidence score may be determined 406 for each user of a population of users based on the generated user model. As a result, a targeting cluster of users may be created by selecting 408 similar users from the population of users based on the confidence scores. The advertisement associated with the training cluster may then be provided to a viewing user based on whether the viewing user is in the targeting cluster of users.

Other Uses of Targeting Clusters Generated from User Models

In one embodiment, a social networking system 100 may enable advertisers to target users that are interested in a particular page or concept on the social networking system 100. For example, users that have previously expressed an interest in a page on the social networking system, such as a page on “Running,” may be targeted by advertisers on the social networking system 100 by specifying targeting criteria to include users that are similar to users that are interested in that page. For example, a user that is a “fan” of a “Running” page may be very interested in new running shoe technology. Another user that is similar to that user may also have an interest in running shoe technology. Advertisers for running shoes may include targeting criteria that defines a training cluster of users to include users that are interested in the “Running” page that may generate a larger targeting cluster of users that are similar to those users interested in the “Running” page on the social networking system. In exchange for consenting to enable other advertisers to target users that have expressed an interest in a page, the social networking system may employ a revenue sharing model to share profits with the administrator of the page from the advertisements that target those users. The administrator of the page is then incentivized to increase her fan base by producing content items on the social networking system, such as pictures of marathon runners, special promotions available only to “fans” of the page, and weekly updates on special events. Pages created by users of the social networking system, such as pages for dancing styles like “Krumping,” may also be targeted by advertisers to generate targeting clusters of users based on training clusters of users comprising the users that are interested in the pages created by the users of the social networking system.

Other revenue sharing models may be implemented by a social networking system to incentivize advertisers to enhance the user experience on the social networking system. For example, an administrator of a particular application that has been installed by a training cluster of users may be provided a share of revenue from advertisers of other applications that wish to target advertisements to a targeting cluster of users based on the training cluster of users that installed the particular application. As another example, a training cluster of users that previously clicked on an advertisement associated with a particular advertiser may be provided to other advertisers as part of targeting criteria for targeting their advertisements. For example, a less sophisticated advertiser may wish to target an advertisement to users that clicked on an advertisement by Lady Gaga. The social networking system may enable the less sophisticated advertiser to identify “Lady Gaga” as a particular advertiser whose fan base, or users that have clicked on advertisements by the particular advertiser, includes users, as well as other similar users that have not clicked on the advertisements, that the less sophisticated advertiser may wish to target. The particular advertiser may be provided with a share of the revenue from those advertisements in exchange for allowing the social networking system to enable the training cluster of users to be used for generating targeting clusters for advertisements by other advertisers.

In another embodiment, the social networking system 100 may automatically learn the behaviors of an advertisement and retarget the advertisement based on the learned behaviors. For example, the social networking system 100 may select the users that are responding to an advertisement, through observing click-through rates and other conversion metrics, and retarget the advertisement to a targeting cluster that was generated based on a training cluster of users that responded to the advertisement. This retargeting may be performed automatically by the social networking system 100, in one embodiment. As a result, the advertisement may be retargeted to a more receptive audience for the advertisement.

Selection of an advertisement by the social networking system 100 to be provided for display to a viewing user of the social networking system may utilize a bidding auction algorithm that selects the advertisement based on an expected value of the advertisement. The social networking system may provide an advertisement having targeting criteria that defines a training cluster of users that may be used to generate a targeting cluster of users by enabling that advertisement to be viewable by users in the generated targeting cluster of users. For a viewing user, the advertisement may be marked as a candidate advertisement and then scored against other candidate advertisements and selected based on the scoring algorithm.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a plurality of ad objects in a social networking system corresponding to a plurality of advertisements for display to users of the social networking system;
maintaining a plurality of user profile objects in a social networking system, the plurality of user profile objects associated with a plurality of users of the social networking system;
receiving a selection of targeting criteria for an advertisement by an advertiser, where the targeting criteria of the advertisement includes targeting the advertisement to users that are similar to a training cluster of users;
determining the training cluster of users for the advertisement based on the selection of the targeting criteria;
determining a targeting cluster of users for the advertisement based on the training cluster of users; and
for a viewing user in the targeting cluster of users interacting with the social networking system, providing the advertisement by the advertiser to the viewing user.

2. The method of claim 1, wherein determining the training cluster of users for the advertisement based on the targeting criteria further comprises:
receiving a selection of a page on the social networking system as part of the selection of the targeting criteria;
determining the training cluster of users comprising a subset of the plurality of users associated with a subset of the plurality of user profile objects associated with the page on the social networking system.

3. The method of claim 2, further comprising:
providing a share of revenue collected from the advertisement to an administrator of the page.

4. The method of claim 2, further comprising:
providing an interface for selecting a brand associated with an advertiser of a plurality of advertisers, where the interface is used for selecting targeting criteria for advertisements on the social networking system and the brand is embodied in the page of the social networking system.

5. The method of claim 1, wherein determining the training cluster of users for the advertisement based on the targeting criteria further comprises:
receiving a selection of an action type on the social networking system as part of the selection of the targeting criteria;
determining the training cluster of users comprising a subset of the plurality of users associated with a subset of the plurality of user profile objects associated with the action type on the social networking system.

6. The method of claim 1, wherein the targeting cluster of users is larger than the training cluster of users.

7. The method of claim 1, wherein determining the training cluster of users for the advertisement based on the targeting criteria further comprises:
receiving a selection of an application on the social networking system as part of the selection of the targeting criteria;
determining the training cluster of users comprising a subset of the plurality of users associated with a subset of the plurality of user profile objects associated with the application on the social networking system.

8. The method of claim 1, wherein determining a targeting cluster of users for the advertisement based on the training cluster of users further comprises:
generating a user model based on the training cluster of users;
determining a confidence score for each user of a population of users on the social networking system based on the user model; and
determining the targeting cluster of users based on the confidence scores of the population of users.

9. The method of claim 1, wherein providing the advertisement by the advertiser to the viewing user further comprises:
marking the advertisement as a candidate advertisement;
determining a score for the advertisement against a plurality of other candidate advertisements based on a bidding auction; and
selecting the advertisement based on the score.

10. A method comprising:
determining a training cluster of users of a social networking system where the training cluster of users is defined by targeting criteria associated with an advertisement;
generating a user model based on the training cluster of users, where the user model evaluates one or more features of a user to determine a confidence score for the user;
determining a confidence score for each user of a population of users of the social networking system based on the user model;
selecting a plurality of users from the population of users based on the determined confidence scores to create a targeting cluster of users; and
for a viewing user, providing the advertisement associated with the training cluster of users for display to the viewing user based on whether the viewing user is in the targeting cluster of users.

11. The method of claim 10, wherein determining a training cluster of users of a social networking system further comprises:
receiving identifying information of users of the social networking system that are included in the training cluster of users.

12. The method of claim 10, wherein determining a training cluster of users of a social networking system further comprises:
determining identifying information of users of the social networking system that are included in the training cluster of users based on the users previously engaging with a selected advertisement.

13. The method of claim 10, wherein generating a user model based on the training cluster of users further comprises:
receiving a keyword profile describing each user of the training cluster of users, the keyword profile including a plurality of keywords;
determining a list of keyword features for the user model, the list of keyword features comprising a selection of keywords from the keyword profiles of the training cluster of users; and
generating the user model based on the list of keyword features.

14. The method of claim 10, wherein generating a user model based on the training cluster of users further comprises:
receiving demographics information describing each user of the training cluster of users;
determining a list of demographics features for the user model, the list of demographics features comprising a selection of types of demographics information describing the training cluster of users; and
generating the user model based on the list of demographics features.

15. The method of claim 10, wherein generating a user model based on the training cluster of users further comprises:
receiving a user engagement history for each user of the training cluster of users, the user engagement history for each user including a history of behavior for the user;
determining a user engagement distribution for the training cluster of users based on the received user engagement histories for the training cluster of users; and
generating the user model using the user engagement distribution for the training cluster of users.

16. The method of claim 15, wherein selecting similar users from the population of users based on confidence scores of the similar users further comprises:
generating a plurality of bins based on the user engagement distribution for the training cluster of users;
distributing the population of users into the plurality of bins based on user engagement histories of the population of users; and
selecting a top percentage of similar users from each of the plurality of bins based on confidence scores of the similar users.

17. The method of claim 10, further comprising:
storing the user model for the advertisement in the social networking system;

18. The method of claim 10, wherein a population of users includes users located in a specified geographic location.

19. A method comprising:
maintaining a plurality of user profile objects on a social networking system, the plurality of user profile objects representing a plurality of users of the social networking system;
maintaining a plurality of edge objects connecting a plurality of nodes in the social networking system, where a subset of the plurality of nodes represent a plurality of advertisers;
determining a subset of the plurality of user profile objects associated with a specified advertiser based on at least one edge object connecting at least one node representing the specified advertiser to each of the user profile objects in the subset of the plurality of user profile objects;
determining a plurality of features for a training model based on the subset of the plurality of user profile objects;
determining a plurality of confidence scores for the subset of the plurality of user profile objects based on the training model;
selecting a plurality of targeted user profile objects based on the plurality of confidence scores; and
storing the plurality of targeted user profile objects as a cluster in the social networking system.

20. The method of claim 19, wherein a subset of the plurality of edge objects are generated based on a plurality of graph actions performed by a subset of the plurality of users on a plurality of graph objects on external systems, the plurality of graph actions and the plurality of graph objects defined by a plurality of entities external to the social networking system.

21. The method of claim 19, wherein the cluster is filtered to include a subset of the plurality of targeted user profile objects based on the subset of the plurality of targeted user profile objects associated with the subset of the plurality of user profile objects associated with the specified advertiser.

22. The method of claim 19, wherein the cluster is filtered to include a subset of the plurality of targeted user profile objects based on a specified geographic location.

23. The method of claim 19, wherein the training model comprises a machine learning model.

24. The method of claim 19, wherein determining a plurality of features for a training model based on the subset of the plurality of user profile objects further comprises:
determining a plurality of affinity scores for a plurality of interests based on the subset of the plurality of user profile objects as the plurality of features for the training model.

25. The method of claim 19, wherein determining a plurality of features for a training model based on the subset of the plurality of user profile objects further comprises:
receiving a performance metric for a feature in the training model; and
modifying the training model based on the performance metric for the feature.

26. The method of claim 19, further comprising:
storing the cluster as targeting criteria for an advertisement in the social networking system.
